(19) United States
(12) Patent Application Publication
(10) Pub. No.: US 2014/0338395 A1
(43) Pub. Date: Nov. 20, 2014

(54) Method of Separating Carbon Dioxide from Liquid Acid Gas Streams

(71) Applicant: EXXON MOBIL UPSTREAM RESEARCH COMPANY, Houston, TX (US)

(72) Inventors: Russell H. Oelfke, Houston, TX (US); Tor Vestad, Arvada, CO (US)

(21) Appl. No.: 14/364,399

(22) PCT Filed: Nov. 16, 2012
(86) PCT No.: PCT/US2012/065652

§ 371 Date: Jun. 11, 2014

Related U.S. Application Data
(60) Provisional application No. 61/578,041, filed on Dec. 20, 2011.

(51) Int. Cl. B01D 53/14; E21B 43/16; B09B 1/00; F25J 3/06

(52) U.S. Cl. CPC B01D 53/1418; B01D 53/1431; B01D 53/1468; B01D 53/1475; F25J 3/067; E21B 43/164; B09B 1/006
USPC 62/620; 95/158; 96/193; 96/181; 62/617; 62/600; 166/305.1; 588/250; 588/313

(57) ABSTRACT

Embodiments described herein provide methods and systems for generating a CO₂ product stream. A method described includes generating a liquid acid gas stream including H₂S and CO₂. The liquid acid gas stream is flashed to form a first vapor stream and a bottom stream. The bottom stream is fractionated to form a second vapor stream and a liquid acid waste stream. The first vapor stream and the second vapor stream are combined to form a combined vapor stream. The combined vapor stream is treated in an absorption column to remove excess H₂S, forming the CO₂ product stream.

### CROSS-REFERENCE TO RELATED APPLICATION

This application claims the benefit of U.S. Provisional Patent Application 61/578,041 filed Dec. 20, 2011 entitled METHOD OF SEPARATING CARBON DIOXIDE FROM LIQUID ACID GAS STREAMS, the entirety of which is incorporated by reference herein.

### FIELD OF THE INVENTION

The present application is directed to the separation of carbon dioxide from a liquid acid gas stream, wherein the liquid acid gas stream is composed primarily of hydrogen sulphide and carbon dioxide.

### BACKGROUND

Natural gas reservoirs may often contain high levels of acid gases, such as CO₂ and H₂S. In these cases, a cryogenic process may provide an efficacious way to separate the acid gases from the methane. The cryogenic process could include a simple bulk fractionation, a Ryan-Holmes process, or a more complex cryogenic fractionation process. The cryogenic processes separate methane from CO₂ and H₂S by condensation and fractionation, and can produce the acid gas in a liquid phase for efficient disposal via pumping. However, in the cryogenic processes the H₂S is separated with the CO₂ in a single liquid acid gas stream. Often, the acid gas will be immediately reinjected for disposal, where the mixture will not cause any problems.

However, the CO₂ may be reused or sold for example, for enhanced oil recovery (EOR) or other purposes, if the H₂S and other sulfur compounds can be removed. When CO₂ and H₂S are mixed, they form a mixture that is difficult to separate. Separating H₂S and CO₂ usually involves vaporizing the entire acid gas stream and using selective chemical or physical solvents for separation. This increases the disposal cost of the residual, often sulfur containing, acid gas stream, since it is no longer in the liquid phase and requires compression instead of pumping.

FIG. 1 is a temperature-composition phase plot 100 showing the equilibrium concentrations of CO₂ in a mixture with H₂S at 100 psia. The x-axis 102 indicates the mole fraction of CO₂, while the y-axis 104 represents the temperature in ° F. (° C.). The concentration of the CO₂ in the vapor phase 106 approaches the concentration of the CO₂ in the liquid phase 108 at>90% CO₂.

FIG. 2 is a temperature-composition phase plot 200 showing the equilibrium concentrations of CO₂ in a mixture with H₂S at 600 psia. Like numbered items are as described with respect to FIG. 1. As this plot 200 shows, the concentrations in the vapor phase 106 and liquid phase 108 are closer at higher pressures. As these plots 100 and 200 indicate, complete separation by fractionation cannot be achieved without some additional separation processes. Pure H₂S could be produced by fractionation, but pure CO₂ would be impractical, or even infeasible.

Although fractionation may not be used for complete separation of CO₂, commercial techniques due exist for separating clean CO₂ from a CO₂/H₂S mixture. For example, selective amine solvent absorption, such as by MDEA or Flexsorb/SE, can be used to absorb H₂S from a vapor acid gas stream, producing a pure CO₂ vapor stream, and an H₂S/CO₂ mixed vapor stream. In another example, some physical solvents, such as Selexol, have selectivity's, or K-Values, that allow the separation of H₂S and CO₂ when the solvent is present. Other methods, using gas permeation membranes or molecular sieves, could be used in conjunction with fractionation or solvents to achieve H₂S and CO₂ separation.

In one example, U.S. Pat. No. 5,335,504 to Durr, et al., discloses a process for recovering carbon dioxide from a natural gas stream. The process may be used to recover CO₂ that has been injected for enhanced oil recovery. The process is based on a cryogenic distillation column, but does not discuss the separation of CO₂ from a mixture with H₂S.

Further, U.S. Pat. No. 4,318,723 to Holmes discloses a cryogenic distillative separation of acid gases from methane, hereinafter termed the “Ryan-Holmes Process.” The Ryan-Holmes Process is a method of eliminating solids formation during a cryogenic distillative separation of acid gases from methane. The method includes adding an agent to control solids formation to a zone of a distillation column at which solids formation may occur. Typical agents are C₂-C₅ alkanes or other nonpolar liquids which are miscible with methane at the column conditions. Preventing the formation of solids permits a more complete separation to be achieved. The Ryan-Holmes Process can generate a liquid acid gas stream, but does not discuss separating CO₂ from a mixture with H₂S.

Another technique for cryogenic purification of natural gas is provided in International Patent Application Publication No. WO/2008/091316, which discloses a controlled freeze zone tower. The controlled freeze zone tower is a cryogenic distillation tower which allows for the separation of a fluid stream containing at least methane and carbon dioxide. The cryogenic distillation tower has a lower stripping section, an upper rectification section, and an intermediate spray section. The intermediate spray section includes a plurality of spray nozzles that inject a liquid freeze zone stream. The nozzles are configured such that substantial liquid coverage is provided across the inner diameter of the intermediate spray section. The liquid freeze zone stream generally includes methane at a temperature and pressure whereby both solid carbon dioxide particles and a methane-enriched vapor stream are formed. The tower may further include one or more baffles below the nozzles to create frictional resistance to the gravitational flow of the liquid freeze zone stream. This aids in the breakout and recovery of methane gas. Additional internal components are provided to improve heat transfer and to facilitate the breakout of methane gas. As for the Ryan Holmes Process, the controlled freeze zone tower can generate a liquid acid gas stream, but does not discuss separating CO₂ from a mixture with H₂S.

In addition to the newer cryogenic techniques, numerous techniques have traditionally been used to prepare natural gas for marketing to customers. Collectively, these techniques are referred to herein as “warm gas processing.” In warm gas processing, the raw gas is processed to remove acid gases, such as hydrogen sulfide and carbon dioxide. This was historically performed by amine treatment, in which an amine reacts with the acid gas. When exhausted, the amine may be regenerated to remove the acid gas. More recently, newer technology has been developed, based on the use of polymeric membranes to separate carbon dioxide and hydrogen sulfide from a natural gas stream.

The acid gases can then be routed into a sulfur recovery unit which converts the hydrogen sulfide in the acid gas into sulfur products, such as elemental sulfur or sulfuric acid. After removal of the acid gases, water vapor can be removed, using any number of methods.

Other components may be removed from the remaining product, such as mercury, and natural gas liquids. This produces a gas that may have methane blended with a number of inert and hydrocarbon components, including nitrogen and helium, among others. Higher carbon number components, such as ethane and heavier hydrocarbons, may be removed and marketed separately as natural gas liquids (NGL), liquid propane gas (LPG), and the like.

All of these methods for isolating CO₂ from a CO₂/H₂S mixture have the same drawback in that the acid gas stream must be fully vaporized, since the separation occurs in the vapor phase. Further all of the products are produced as vapor streams. Since liquid acid gas is easier to dispose of (less energy via pumping rather than compression) and the acid gas is available in the liquid phase when cryogenic separation processes are used, it would be useful for one or both of the products to be produced as liquids. For example, it would be useful for a waste injection stream, usually containing H₂S, to be a liquid stream, since that stream would normally require a higher final pressure than a clean, product CO₂ stream. Thus, there is a need for a process to separate clean CO₂ from mixed H₂S/CO₂, liquid acid gas streams, while maintaining the residual acid gas in the liquid phase for easy disposal.

### SUMMARY

An embodiment described herein provides a method for generating a CO₂ product stream. The method includes generating a liquid acid gas stream comprising H₂S and CO₂. The liquid acid gas stream is flashed to form a first vapor stream and a bottom stream. The bottom stream is fractionated to form a second vapor stream and a liquid acid waste stream. The first vapor stream and the second vapor stream are combined to form a combined vapor stream and the combined vapor stream is treated with a physical solvent to remove excess H₂S, forming the CO₂ product stream.

Another embodiment provides a system for generating a CO₂ enriched stream. The system includes an acid gas flash drum configured to flash a portion of a liquid acid gas stream into a vapor stream and a liquid stream. A bulk liquid stripper is configured to contact the liquid stream with an acid gas stream and flash at least a portion of the liquid stream into an overhead stream and a bottoms stream, wherein the overhead stream and the vapor stream are mixed to form a combined gas stream, and the bottoms stream is disposed of as a concentrated acid gas stream. An absorption column is configured to contact the combined gas stream with a preloaded absorbent stream, wherein a rich absorbent stream exits the bottom of the absorption column and a CO₂ enriched vapor stream exits the top of the column.

Another embodiment provides a method for purifying a natural gas stream. The method includes dehydrating the natural gas stream and cryogenically separating the natural gas stream into a methane rich fraction, a natural gas liquids fraction, and a liquid acid gas stream. The liquid acid gas stream is fractionated to form a CO₂ enriched stream and a liquid acid waste stream. The CO₂ enriched stream is treated with an absorbent to remove excess H₂S forming a CO₂ product stream.

### BRIEF DESCRIPTION OF THE DRAWINGS

The advantages of the present techniques are better understood by referring to the following detailed description and the attached drawings, in which:

FIG. 1 is a temperature-composition phase plot showing the equilibrium concentrations of CO₂ in a mixture with H₂S at 100 psia;

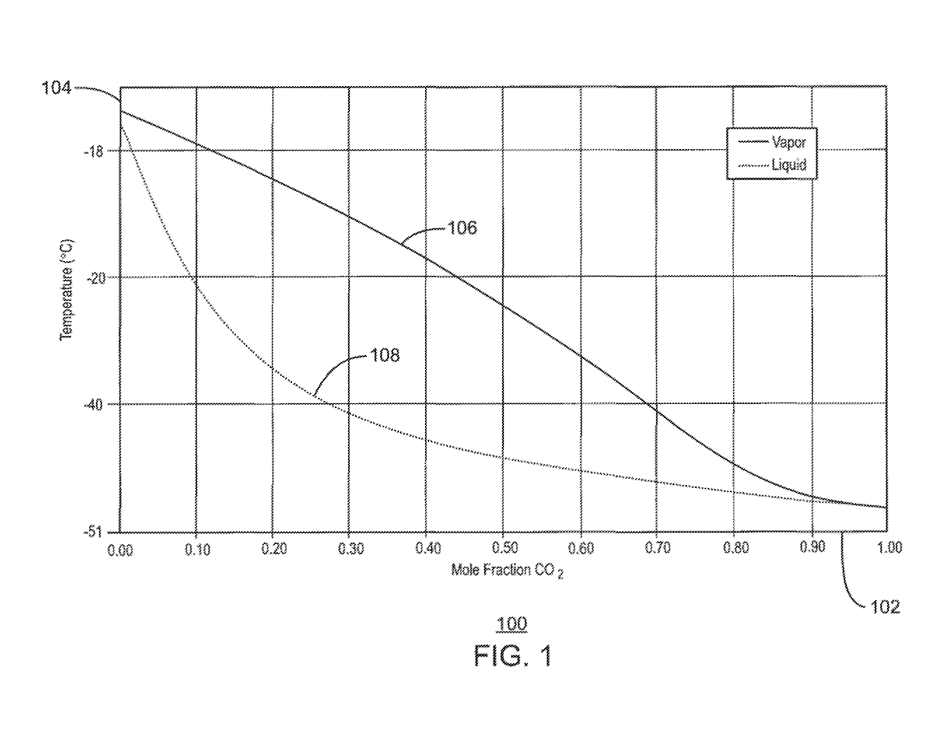

FIG. 2 is a temperature-composition phase plot showing the equilibrium concentrations of CO₂ in a mixture with H₂S at 600 psia;

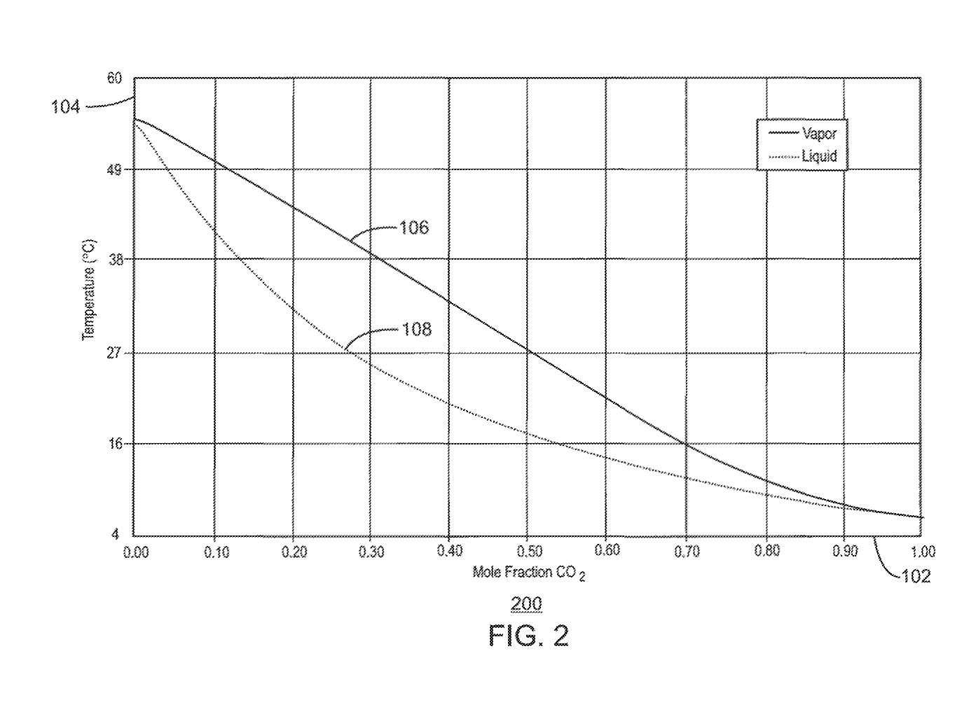

FIG. 3 is a block diagram of a system that can be used to isolate a CO₂ product stream as part of a natural gas purification process;

FIG. 4 is a simplified process flow diagram of a cryogenic separation system that can be used to generate a liquid acid gas stream;

FIG. 5 is a simplified process flow diagram of a CO₂ separation process that separates a liquid acid gas stream into a CO₂ product stream and a liquid acid gas waste stream;

FIG. 6 is a simplified process diagram of an absorbent regeneration system that removes acid gases from a physical solvent from FIG. 5 and returns a lean absorbent stream to the absorbent column shown in FIGS. 5; and

FIG. 7 is a block diagram of a method for generating a CO₂ product stream and a liquid acid gas waste stream using a combined system.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Acid gases” are contaminants that are often encountered in natural gas streams. Typically, these gases include carbon dioxide (CO₂) and hydrogen sulfide (H₂S), although any number of other contaminants may also form acids. Acid gases are commonly removed by contacting the gas stream with an absorbent, such as an amine, which may react with the acid gas. When the absorbent becomes acid-gas “rich,” a desorption step can be used to separate the acid gases from the absorbent. The “lean” absorbent is then typically recycled for further absorption. As used herein a “liquid acid gas stream” is a stream of acid gases that are condensed into the liquid phase, for example, including CO₂ dissolved in H₂S and vice-versa.

The Claus process is a process discovered over 120 years ago that has been used by the natural gas and refinery industries to recover elemental sulfur from hydrogen sulfide-containing gas streams. Briefly, the Claus process for producing elemental sulfur comprises two major sections. The first section is a thermal section where H₂S is converted to elemental sulfur at approximately 1,800-2,200° F. No catalyst is present in the thermal section. The second section is a catalytic section where elemental sulfur is produced at temperatures between 400-650° F. over a suitable catalyst (such as alumina). The reaction to produce elemental sulfur is an equilibrium reaction and, hence, there are several stages in the Claus process where separations are made in an effort to enhance the overall conversion of H₂S to elemental sulfur. Each stage involves heating, reacting, cooling and separation.

As used herein, a “column” is a separation vessel in which a counter current flow is used to isolate materials on the basis of differing properties. In an absorbent column, a physical solvent is injected into the top, while a mixture of gases to be separated is flowed through the bottom. As the gases flow upwards through the falling stream of absorbent, one gas species is preferentially absorbed, lowering its concentration in the vapor stream exiting the top of the column. In a fractionation column, liquid and vapor phases are counter-currently contacted to effect separation of a fluid mixture based on boiling points or vapor pressure differences. The high vapor pressure, or lower boiling, component will tend to concentrate in the vapor phase whereas the low vapor pressure, or higher boiling, component will tend to concentrate in the liquid phase. Cryogenic separation is a separation process carried out in a column at least in part at temperatures at or below 150 degrees Kelvin (K). To enhance the separation, both types of columns may use a series of vertically spaced trays or plates mounted within the column and/or packing elements such as structured or random packing. Columns may often have a recirculated stream at the base to provide heat energy for boiling the fluids, called reboiling. In a fractionation column, a portion of the overhead vapor may be condensed and pumped back into the top of the column as a reflux stream, which can be used to enhance the separation and purity of the overhead product. A bulk liquid stripper is related to a fractionation column. However, the bulk liquid stripper functions without the use of a reflux stream and, thus, cannot produce a high-purity overhead product.

“Cold box” refers to an insulated enclosure which encompasses sets of process equipment such as heat exchangers, columns, and phase separators. Such sets of process equipment may form the whole or part of a given process.

“Compressor” refers to a device for compressing a working gas, including gas-vapor mixtures or exhaust gases. Compressors can include pumps, compressor turbines, reciprocating compressors, piston compressors, rotary vane or screw compressors, and devices and combinations capable of compressing a working gas.

“Cryogenic distillation” has been used to separate carbon dioxide from methane since the relative volatility between methane and carbon dioxide is reasonably high. The overhead vapor is enriched with methane and the bottoms product is enriched with carbon dioxide and other heavier hydrocarbons. Cryogenic distillation processing requires the proper combination of pressure and temperature to achieve the desired product recovery.

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state.

“Heat exchanger” refers to any equipment arrangement adapted to allow the passage of heat energy from one or more streams to other streams. The heat exchange may be either direct (e.g., with the streams in direct contact) or indirect (e.g. with the streams separated by a mechanical barrier). The streams exchanging heat energy may be one or more lines of refrigerant, heating or cooling utilities, one or more feed streams, or one or more product streams. Examples include a shell-and-tube heat exchanger, a cryogenic spool-wound heat exchanger, or a brazed aluminum-plate fin type, among others.

A “hydrocarbon” is an organic compound that primarily includes the elements hydrogen and carbon, although nitrogen, sulfur, oxygen, metals, or any number of other elements may be present in small amounts. As used herein, hydrocarbons generally refer to organic materials that are harvested from hydrocarbon containing sub-surface rock layers, termed reservoirs. For example, natural gas is normally composed primarily of the hydrocarbon methane.

The term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C₁) as a significant component. Raw natural gas will also typically contain ethane (C₂), higher molecular weight hydrocarbons, one or more acid gases (such as carbon dioxide, hydrogen sulfide, carbonyl sulfide, carbon disulfide, and mercaptans), and minor amounts of contaminants such as water, helium, nitrogen, iron sulfide, wax, and crude oil.

Low-BTU natural gas indicates a natural gas with a BTU content that is generally lower than commercial standards for pipeline service, e.g., less than about 1000 BTU per standard cubic foot. While low-BTU natural gas can be upgraded to match pipeline gas standards, it may not be economically practical. For this reason, low-BTU natural gas reservoirs were often not harvested in the past. However, low-BTU natural gas can be used to fire power plants, upgrading the energy to electricity.

“Pressure” is the force exerted per unit area by the gas on the walls of the volume. Pressure can be shown as pounds per square inch (psi). “Atmospheric pressure” refers to the local pressure of the air. “Absolute pressure” (psia) refers to the sum of the atmospheric pressure (14.7 psia at standard conditions) plus the gage pressure (psig). “Gauge pressure” (psig) refers to the pressure measured by a gauge, which indicates only the pressure exceeding the local atmospheric pressure (i.e., a gauge pressure of 0 psig corresponds to an absolute pressure of 14.7 psia). The term “vapor pressure” has the usual thermodynamic meaning. For a pure component in an enclosed system at a given pressure, the component vapor pressure is essentially equal to the total pressure in the system.

A “separation vessel” is a vessel wherein an incoming feed is separated into individual vapor and liquid fractions. A separation vessel may include a flash drum in which a stream is flashed to form vapor and liquid components. The vapor component is removed from an upper outlet, while the liquid component is removed from a lower outlet.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

Overview

Methods and systems described herein use a combination of fractionation and absorption by a physical solvent to produce a vaporized CO₂ product stream and a residual liquid acid waste stream. The techniques use an initial fractionation process that generates a CO2 enriched vapor stream and the liquid acid waste stream that includes both CO₂ and H₂S. The CO₂ enriched vapor stream is contacted with a physical solvent or absorbent, such as Selexol, Purisol, or Rectisol, among others. The physical solvent can remove the H₂S from a vapor containing CO₂ and H₂S, providing a purified CO₂ stream which can be used in other applications or provided as a product. The techniques allow a portion of the CO₂ in a liquid acid gas stream to be extracted and purified, while the residual CO₂ and H₂S remains in the liquid phase. The purified CO₂ is produced in the vapor phase, but near the feed pressure.

In this process, the cool liquid acid gas is pre-heated and fed to the top of a reboiled, bulk liquid stripper. A desired volume of CO₂ is vaporized within the bulk liquid stripper. The vapor from the bulk liquid stripper is fed to an absorber column and treated with a physical solvent to remove residual sulfur compounds. This produces the clean CO₂ product, near feed pressure. The remaining liquid acid gas, from the bottom of the bulk liquid stripper, can be pumped to injection pressures, for example, for disposal in a waste well.

The rich physical solvent from the absorber column goes to a regeneration system, in which the regenerated acid gas is compressed and recycled. The compressed acid gas is injected into the bottom of the bulk liquid stripper, where H₂S is reabsorbed into the liquid acid gas and provides a portion of the stripping gas to vaporize the desired CO₂ volume.

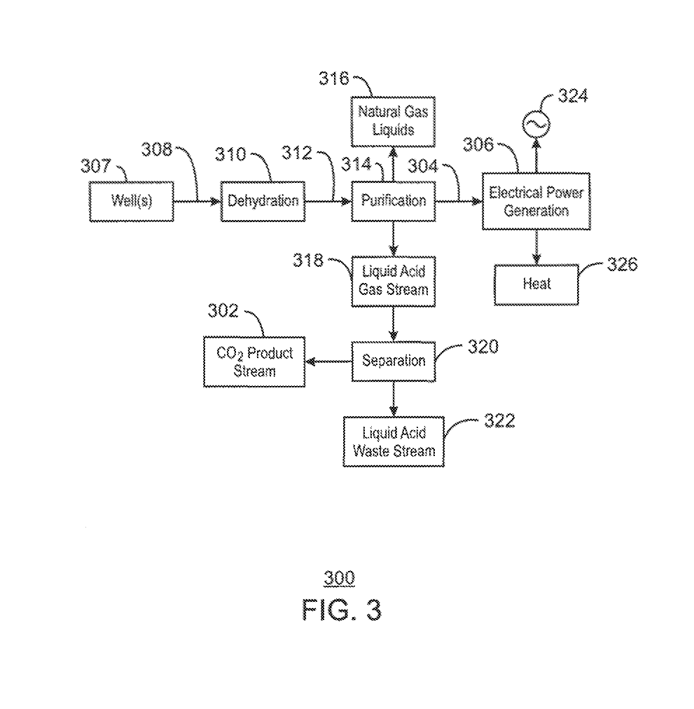

FIG. 3 is a block diagram of a system 300 that can be used to isolate a CO₂ product stream 302 as part of a natural gas purification process. The natural gas 304 may, for example, be used to power an electrical generation system 306. The system 300 is not limited to the blocks shown, but may include any number of configurations, including, for example, providing a gas stream 304 to other customers through a commercial pipeline.

In the system 300, one or more production wells 307 can be used to produce a raw natural gas stream 308. The raw natural gas stream may include a substantial amount of acid gas, and, in some embodiments, may have a low-BTU content, e.g., between about 500 and 950 BTUs per standard cubic foot.

The raw natural gas stream 308 can be fed to a dehydration unit 310 in which water vapor may be removed using glycol dehydration, desiccants, or a Pressure Swing Adsorption (PSA) unit, among other processes. The dehydration unit 310 is not limited to the arrangement shown, but may be included at any number of points in the system 300, or eliminated if not needed. Generally, dehydration is used to prepare the natural gas for cryogenic separation by removing water, which could freeze and plug the systems.

The dehydrated stream 312 may be fed to a purification system 314, which may use any number of processes to remove contaminates, including natural gas liquids (NGL) 316 and acid gases. The purification system 314 may include a cryogenic distillation unit, for example, using a Ryan-Holmes process. Other cryogenic distillation techniques may be used, such as the controlled freeze zone (CFZ™) technology available from Exxon Mobil. Both of these cryogenic processes can generate a liquid acid gas stream 318 that included CO₂ and H₂S, as well as other compounds. In various embodiments, any number of other techniques that generate a liquid acid gas stream may also be used for purification, such as a warm gas processing system. In addition to removing the liquid acid gas stream 318, the purification system 314 may also remove higher carbon number hydrocarbons, e.g., C₂ and higher. The higher carbon number hydrocarbons may be combined to form the NGL stream 316, among others, which may also be marketed as a product.

The liquid acid gas stream 318 from the purification may be further processed to generate the CO₂ stream 302, which may be used for enhanced oil recovery, commercial sales, or other purposes. The processing is performed in a separation system 320 that fractionates the liquid acid gas stream 318 to generate a liquid acid waste stream 322, which can be disposed of, for example by injection into a waste disposal well. The liquid acid waste stream 322 can be used to produce sulfur using the Claus process. As described herein, the fractionation process also generates a vapor stream comprising CO₂ with sulfur compounds as impurities. The vapor stream is contacted with a physical solvent to remove the remaining H₂S and sulfur compounds to produce the CO₂ product stream 302.

After purification, the purified gas stream 304 may be a mixture of methane and various inert gases, such as nitrogen and helium. This gas stream 304 can be directly used, for example, as a low BTU natural gas stream to power an electric power generation system 306. Other operations, such as the separation of a helium enriched stream, may also be performed prior to the usage. An electrical generation plant 306 may provide other, higher value, products for sale, including electrical power 324 to a power grid, heat 326 for other processes, or both. In some embodiments, the electrical generation plant 306 may purchase the product stream 304 from a pipeline associated with the producer. The techniques described herein are not limited to electric power generation using low BTU streams, but may be used with any natural gas purification process in which the separation of acid gases may be useful. For example, the purified natural gas may be marketed through a pipeline distribution system.

The system 300 described herein has a number of advantages over current technologies. For example, it produces a liquid acid waste stream for easy injection, while producing a clean vapor CO₂ stream for EOR or other uses. The system 300 also has the ability to remove COS from the CO₂ product. Physical solvents alone, like Selexol, cannot efficiently separate COS from CO₂, since the K-values are very similar. However, in the bulk liquid stripper, the COS naturally separates to the bottom product and is eliminated from the CO₂ product with the liquid acid gas waste stream, before treatment with the physical solvent.

The system 300 integrates heat demands and cooling sources to decrease the need for external refrigeration in the separation system 320. The physical solvent process works best when chilled, since the lower temperature reduces the required solvent circulation rate. Since the acid gas feed is in the liquid phase and needs to be partially vaporized, the feed vaporization requirements can be efficiently matched to the physical solvent chilling requirements. If a warm gas processing system is used, additional refrigeration may be provided to enhance the process.

The system 300 can function while controlling the water content of the liquid acid waste stream 322. Some physical solvent processes, like Selexol, will produce wet regeneration gases. If all of the liquid acid gas feed 318 is treated in this way, the liquid acid waste stream 322 will be wet and may need further dehydration. In this process described herein, the majority of the liquid acid gas feed 318 only goes through the bulk liquid stripper, which does not add water to the liquid acid gas stream.

In the process, the acid gas produced from regenerating the physical solvent can be cooled after compression to reduce its water content. The reduced water content adds water to the bulk stripper bottom liquid product at a rate low enough to allow the injected acid gas water content to be below saturation. This may allow the acid gas stream to be injected without further dehydration or other processing.

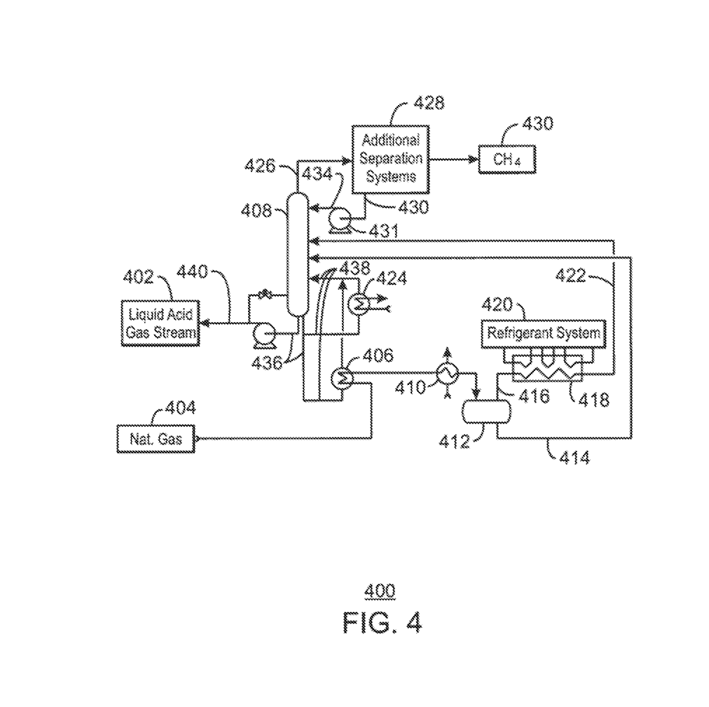

The purification system 314 can include any number of processes that produce a liquid acid gas stream, including, for example, the Ryan-Holmes process, a bulk fractionation process, or a controlled freeze zone plants. The separation system 320 can be retrofitted onto an existing purification system 314 to have all or part of the liquid acid gas stream produced by these processes re-directed to the separation system 320 to extract CO₂ for EOR or sales. The separation system 320 can be added later, and the new facility need only be large enough to produce the desired volume of CO₂. One example of a process that may be used is shown in FIG. 4.

Cryogenic Separation Forming a Liquid Acid Gas Stream

FIG. 4 is a simplified process flow diagram of a cryogenic separation system 400 that can be used to generate a liquid acid gas stream 402. In the separation system 400, a natural gas stream 404 can be cooled and provide some of the heat used by the process, for example, by being passed through a heat exchanger 406 to provide heat for reboiler service on a cryogenic fractionation column 408. The natural gas stream 404 can be further chilled in another heat exchanger 410, and then flashed into a flash drum 412. The bottoms stream 414 from the flash drum 412 can be sent into the cryogenic fractionation column 408. The vapor stream 416 from the overhead of the flash drum 412 can be further cooled in a cold box 418, for example, by exchanging heat with a number of high pressure, mid-pressure, and low pressure refrigerant systems 420. The resulting stream 422 is injected into the cryogenic fractionation column 408. In addition to heating from the heat exchanger 406 on the natural gas feed stream 404, a reboiler heat exchanger 424 may provide additional heating and cooling to the cryogenic fractionation column 408.

The overhead stream 426 from the cryogenic fractionation column 408 will include the methane from the natural gas feed 404, as well as other low boiling point or non-condensable gases, such as nitrogen and helium. Additional separation systems 428, including columns, cold boxes, and the like, may be used to generate a CH₄ product stream 430 at a chosen purity level. A portion 431 of the overhead stream 426 may be fed to a pump 432 to be reinjected into the cryogenic fractionation column 408 as a reflux stream 434.

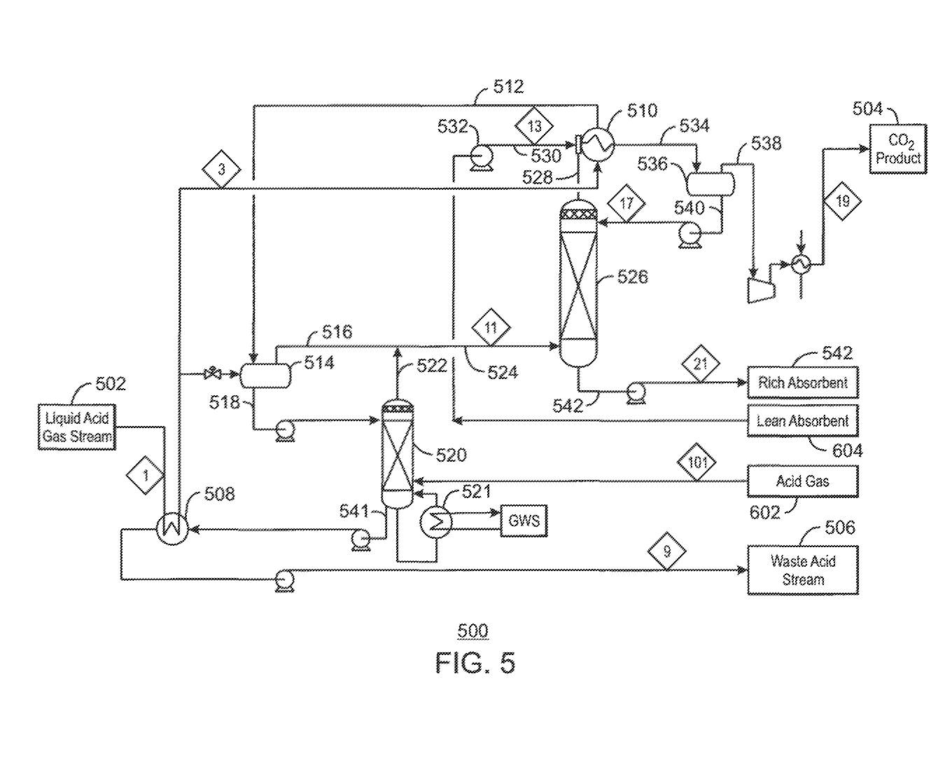

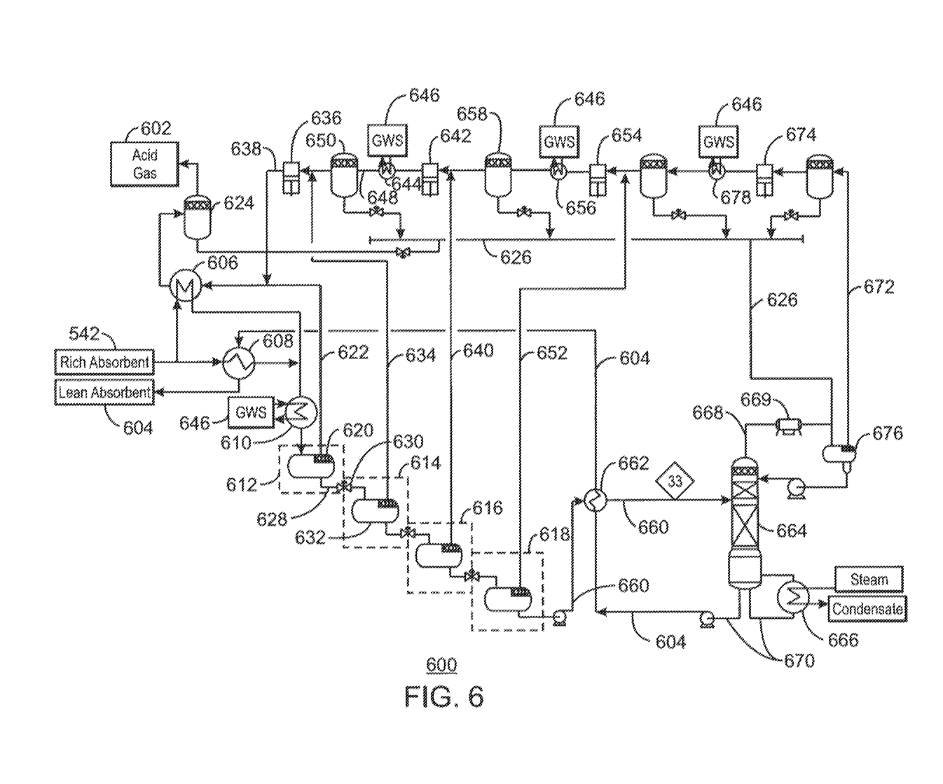

The bottoms stream 436 from the cryogenic fractionation column 408 can be separated into two streams. A reboiler stream 438 is heated and returned to the cryogenic fractionation column 408 to provide heating. An outlet stream 440 is removed from the bottoms stream 436 for disposal. In embodiments, this outlet stream 440 forms the liquid acid gas stream 402 used for the generation of the CO₂ product, as described with respect to FIGS. 5 and 6.

Separation of CO₂ from Liquid Acid Gas Stream

An example of a process for separating CO₂ from a liquid acid gas stream is shown in FIGS. 5 and 6. Tables 1 and 2 present process simulation results for the example, wherein the numbers in diamonds in FIGS. 5 and 6 correspond to the process points in Tables 1 and 2. The simulation results were generated using a process modeling tool, e.g., Aspen HYSYS® from Aspen Technology, Inc. In this example, the feed stream is produced by the cryogenic separation process shown in FIG. 4. However, any process that generates a liquid acid gas stream may be used to provide the feed. In cases in which the separation process is not cryogenic, additional cooling may be used in the process.

TABLE 1
Simulated Values for Process Variables

| | PROCESS POINT: | | | | | |
|---|---|---|---|---|---|---|
| | 1 | 3 | 11 | 101 | 19 | 9 |
| Temperature (° F.) | 48.9 | 53.7 | 71.7 | 92.3 | 105 | 68.0 |
| Pressure (psia) | 890 | 885 | 860 | 885 | 2311 | 947 |
| Flowrate (lb · mole/hr) | 87411 | 87411 | 63668 | 30907 | 32885 | 54655 |
| Flowrate (MMSCFD) | 796.1 | 796.1 | 579.9 | 281.5 | 299.5 | 497.7 |
| Methane (Mole | 0.0019 | 0.0019 | 0.0028 | 501 ppmv | 0.0049 | 178 ppmv |
| Fraction) | | | | | | |
| CO₂ (Mole Fraction) | 0.9450 | 0.9450 | 0.9495 | 0.8979 | 0.9943 | 0.9131 |
| H₂S (Mole Fraction) | 0.0525 | 0.0525 | 0.0474 | 0.0977 | 12 ppmv | 0.0840 |
| COS (ppmv) | 553 | 553 | 330 | 508 | 94 | 828 |
| H₂O (Mole Fraction) | 0 | 0 | 0 | 0.0034 | 670 ppmv | 0.0019 |
| Selexol (Mole | 0 | 0 | 0 | 0 | 0 | 0 |
| Fraction) | | | | | | |

TABLE 2
Simulated Values for Process Variables

| | PROCESS POINT: | | | |
|---|---|---|---|---|
| | 13 | 17 | 21 | 33 |
| Temperature (° F.) | 102.6 | 76.1 | 77.3 | 254.2 |
| Pressure - psia | 935 | 935 | 915 | 50 |
| Flowrate | 6744 | 27791 | 37696 | 7801 |
| (lb · mole/hr) | | | | |
| Flowrate (US gpm) | 2721 | 4311 | 5245 | 2959 |
| Methane (Mole | 0 | 627 ppmv | 411 ppmv | 0 |
| Fraction) | | | | |
| CO₂ (Mole Fraction) | 0 | 0.7498 | 0.7362 | 0.0347 |
| H₂S (Mole Fraction) | 7 ppmv | 28 ppmv | 0.0801 | 0.0951 |
| COS (ppmv) | 0 | 138 | 475 | 165 |
| H₂O | 0.3165 | 0.0835 | 0.0605 | 0.2791 |
| (Mole Fraction) | | | | |
| Selexol (Mole | 0.6835 | 0.1659 | 0.1223 | 0.5909 |
| Fraction) | | | | |

FIG. 5 is a simplified process flow diagram of a CO₂ separation process 500 that separates a liquid acid gas stream 502 into a CO₂ product stream 504 and a liquid acid waste stream 506. The liquid acid gas stream 502 is partially vaporized in two heat exchangers 508 and 510, while providing medium-temperature refrigeration duty to these exchangers. The use of the liquid acid gas stream 502 in these exchangers can reduce, or, in some cases, even eliminate, the need for an external refrigeration system to cool these exchangers.

The partially vaporized acid gas 512 is flowed into a separation vessel 514 to form a vapor stream 516 and a liquid stream 518. The liquid stream 518 is pumped into a bulk liquid stripper 520. The bulk liquid stripper 520 is heated by a reboiler 521, for example, using a heating medium such as a glycol-water mixture.

The vapor stream 516 and the overhead vapor 522 from the bulk liquid stripper 520 are combined to form a vaporized CO₂ stream 524 that is fed to the bottom of an absorbent column 526. The absorbent column 526 may use any number of physical solvents, such as Selexol, Purisol, Rectisol, and others. In this example, Selexol was used for the purposes of the process simulation calculations.

In the absorbent column 526, the remaining H₂S in the vaporized CO₂ stream 524 is removed by a counter current of physical solvent falling from the top of the absorbent column. The column overhead 528 is mixed with a lean Selexol stream 530 from pump 532 and enters an absorber-exchanger 510. The absorber-exchanger 510 pre-saturates the Selexol with CO₂ and removes the heat of absorption by exchanging heat with the feed liquid acid gas stream 502. This pre-saturation step allows the absorbent column 526 to operate at a fairly constant, low temperature and absorb the H₂S in the vapor feed stream at a low total Selexol circulation rate, for example, in comparison to current solvent separation processes that operate at higher temperatures. The CO₂ saturated Selexol stream 534 is flowed into a flash drum 536. The overhead vapor stream from the flash drum 536 provides a purified CO₂ stream 538. The liquid stream from the flash drum 536 is a pre-saturated, chilled Selexol stream 540, which is pumped to the absorbent column 526 to provide the selective separation of the purified CO₂ and H₂S.

The purified CO₂ stream 538 can be compressed and cooled to the desired conditions for the CO₂ product 504. The liquid stream 541 from the bottom of the bulk liquid stripper 520 can be pumped and sub-cooled by exchanging heat with the liquid acid gas stream 502 in exchanger 508, and further pumped to the desired injection or transmission conditions for the liquid acid waste stream 506. The rich Selexol stream 542 from the bottoms of the absorbent column 526 is pumped to an absorbent regeneration system 600, discussed with respect to FIG. 6, for the extraction of the residual H₂S.

FIG. 6 is a simplified process diagram of an absorbent regeneration system 600 that removes acid gases 602 from a physical solvent steam from FIG. 5 and returns a lean absorbent stream 604 to the absorbent column 526 shown in FIG. 5. Like numbered items are as described with respect to FIG. 5. Since a pre-saturated, chilled Selexol stream 540 is injected into the absorbent column 526, the rich Selexol stream 542 is cool. The rich Selexol stream 542 is preheated in exchangers 606 and 608 to recover some refrigeration duty, and then further heated in an exchanger 610 with a heating medium, for example, a glycol-water stream.

The pressure of the rich Selexol stream 542 is then progressively reduced in stages 612, 614, 616, and 618 to allow some of the acid gas to be released in each stage at incrementally decreasing pressures. Although four stages are shown, the number of stages could be increased or decreased depending on the concentration of H₂S in the rich Selexol stream 542. In a first stage 612 the rich Selexol stream 542 is fed to flash drum 620. The overhead vapor stream 622 can be cooled in an exchanger 606, allowing water to condense out and be recovered in a separation vessel 624. The recovered water stream 626 can be further processed to remove more of the dissolved H₂S, while the acid gas 602 is returned to the bulk liquid stripper 520.

The liquid stream 628 from the bottom of the flash drum 620 can be flashed across a valve 630 to lower the pressure prior to injection into a second flash drum 632 in the second stage 614. The vapor stream 634 from the second flash drum 632 is fed to a recompressor 636 and the pressured stream 638 is combined with the overhead vapor stream 622 from the flash drum 622.

Similarly, the vapor stream 640 from a third stage 616 is fed to a recompressor 642 and prior to being flowed through a heat exchanger 644, which can be cooled by a glycol-water stream from a glycol-water heating and cooling system (GWS) 646, as discussed herein. The cooled compressed stream 648 is passed through a separation vessel 650 to remove condensed water, and the remaining vapor stream is combined with the vapor stream 634 from the second flash drum 632 to be fed into the recompressor 636.

The fourth stage 618 is operated in a similar fashion, with a vapor stream 652 fed to a recompressor 654 prior to being cooled in a heat exchanger 656. After cooling, the vapor stream 652 is flowed through a separation vessel 658 to remove condensed water, prior to being combined with the vapor stream 640 from the prior stage 616. These pressures of the vapor stream from each stage 612, 614, 616, and 618 can be matched to the recompression inter-stage pressures to minimize recompression power requirements.

After the pressure reduction in the stages 612, 614, 616, and 618, the reduced pressure Selexol stream 660 is further heated in a rich/lean exchanger 662 and charged to a reboiled regeneration column 664. The reboiled regeneration column 664 is heat by a steam reboiler 666. The overhead vapor stream 668 is cooled in an ambient heat exchanger 669 and then processed in a similar manner to the vapor streams from the stages 612, 614, 616, and 618 to remove the remaining H₂S. The bottom stream 670 from the reboiled regeneration column 664 provides the lean Selexol stream 604, which is pumped through the rich/lean exchanger 662 and exchanger 608, before flowing to the absorber-exchanger 510 (FIG. 5).

The five wet vapor streams 622, 634, 640, 652, and 672 produced during the Selexol regeneration are routed to the recompressors 636, 642, 654, and 674. The wet vapor streams 622, 634, 640, 652, and 672 enter at the appropriate inter-stage pressures to minimize the required compression power. After recompression, the regeneration gas at each stage is cooled to remove water. After all the regeneration gas is compressed and mixed, it is cooled a final time in exchanger 606 to condense as much remaining water as feasible. The acid gas stream 602 carries a small amount of water into the bulk liquid stripper 520. The recovered water stream 626, separated from all the compression inter-stages, is reintroduced to the regenerator reflux accumulator 676, to maintain the Selexol system's water balance.

The cooled, H₂S-rich acid gas 602 is then injected into the bottom of the bulk liquid stripper 520. Here, the H₂S is reabsorbed by the liquid acid gas releasing CO₂ in its place and reducing the amount of reboiler duty required to vaporize the desired volume of CO₂. All the H₂S is, thus, contained in the liquid acid waste stream 506 leaving the bottom of the bulk liquid stripper 520.

Over half of the thermal energy used in the processes described herein is at a low enough low temperature, e.g., below about 150° F., so that the heat can be supplied from the compressor discharge coolers. Thus, a glycol water heating and cooling system (GWS 646) can be used to maximize the thermal efficiency of the overall system by transferring heat from locations it is generated (e.g., at the compressor discharge coolers) to locations that it is used. For example, the GWS 646 system can be heated at the exchangers 644, 656, and 678 in the compressor inter-stages and cooled in the Selexol exchanger 610 and the bulk stripper heaters, minimizing additional utility and fuel requirements.

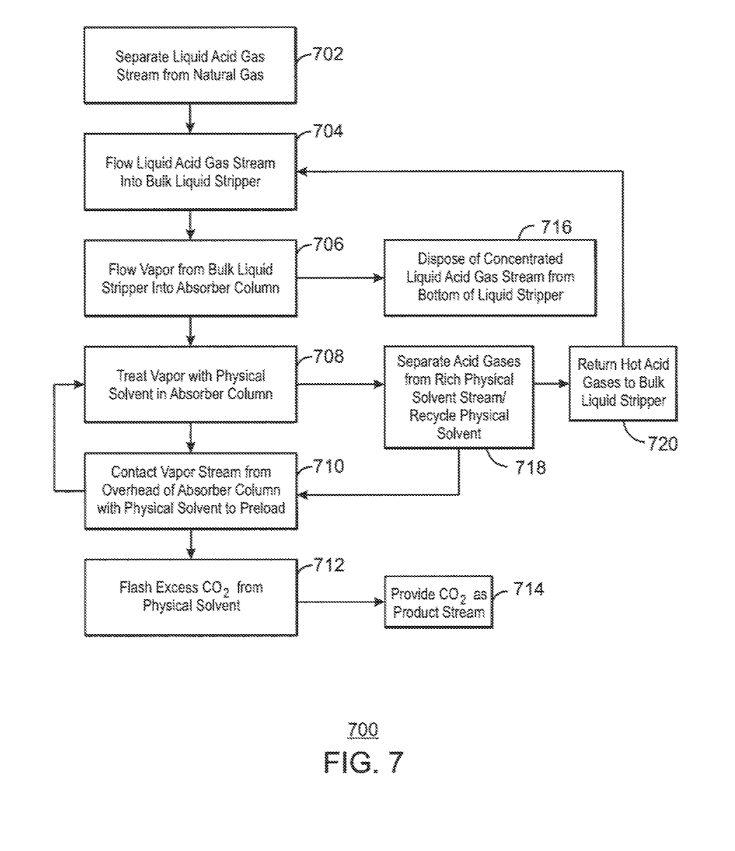

FIG. 7 is a block diagram of a method 700 for generating a CO₂ product stream and a liquid acid gas waste stream using a combined system. The method 700 begins at block 702 with the separation of a liquid acid gas stream from a natural gas product. The liquid acid gas stream may be isolated using a cryogenic separation process as described with respect to FIG. 4. However, any separation process that generates a liquid acid gas stream may be used. At block 704, the liquid acid gas stream may be flowed into a bulk liquid stripper to fractionate CO₂ from the CO₂/H₂S mixture, as described with respect to FIG. 5. At block 706, the CO₂ enriched vapor from the bulk liquid stripper is flowed to an absorber column. At block 708 the vapor is treated with a physical solvent in the absorber column to remove excess H₂S from the CO2. At block 710, the vapor from the overhead of the absorber column is contacted with a lean physical solvent stream to preload the physical solvent with the CO2. The treated stream is then used at block 708 to treat the vapor. At block 712, excess CO₂ is flashed from the physical solvent after preloading and, at block 714, the excess CO₂ is provided as a product.

At block 716, the concentrated liquid acid gas stream isolated at block 706 as the bottoms of the bulk liquid stripper can be disposed of, for example, by injection into a disposal well. The rich physical solvent, e.g., containing a high concentration of H₂S and CO₂, can be processed at block 718 to remove the acid gases, as described with respect to FIG. 6. At block 720, the acid gases can be returned to the bulk liquid stripper for further separation and to provide heating duty. The lean physical solvent generated at block 718 can be pretreated at block 710 to form the preloaded solvent.

### EMBODIMENTS

Embodiments as described herein may include any combinations of the elements in the following numbered paragraphs:

1. A method for generating a CO₂ product stream, including:
generating a liquid acid gas stream including H₂S and CO₂;
flashing the liquid acid gas stream to form a first vapor stream and a bottom stream;
fractionating the bottom stream to form a second vapor stream and a liquid acid waste stream;
combining the first vapor stream and the second vapor stream to form a combined vapor stream; and
treating the combined vapor stream with a physical solvent to remove excess H₂S, forming the CO₂ product stream.

2. The method of paragraph 1, including disposing of the liquid acid waste stream in a waste disposal well.

3. The methods of paragraphs 1 or 2, wherein treating the combined vapor stream includes:
contacting the physical solvent with an enriched CO₂ stream from an absorption column to form a preloaded physical solvent;
flashing the preloaded physical solvent to remove excess CO₂ as the CO₂ product stream; and
injecting the preloaded physical solvent into the absorption column to treat the combined vapor stream.

4. The methods of paragraphs 1, 2, or 3, including:
flowing the bottom stream from the absorption column to a separation system, wherein the bottom stream includes a rich physical solvent; and
separating an acid gas stream from the rich physical solvent.

5. The methods of any of the preceding paragraphs, including injecting the acid gas stream into a bulk liquid stripper to provide heat duty.

6. The methods of any of the preceding paragraphs, including flashing the rich physical solvent in a plurality of stages, wherein each stage is operated at a lower pressure than the proceeding stage.

7. The methods of any of the preceding paragraphs, including:
recompressing a vapor stream from each stage; and
cooling the recompressed vapor stream to remove water to within a solubility limit of the acid gas.

8. The methods of any of the preceding paragraphs, including cooling the preloaded physical solvent by exchanging heat with the liquid acid gas stream.

9. The methods of any of the preceding paragraphs, wherein generating the liquid acid gas stream includes a Ryan-Holms process.

10. The methods of any of the preceding paragraphs, wherein generating the liquid acid gas stream includes a cryogenic process.

11. The methods of any of the preceding paragraphs, including injecting the CO₂ enriched stream into a formation to enhance a recovery of a hydrocarbon.

12. The methods of any of the preceding paragraphs, including disposing of the liquid acid waste stream by generating solid sulfur.

13. A system for generating a CO₂ enriched stream, including:
an acid gas flash drum configured to flash a portion of a liquid acid gas stream into a vapor stream and a liquid stream;
a bulk liquid stripper configured to contact the liquid stream with an acid gas stream and flash at least a portion of the liquid stream into an overhead stream and a bottoms stream, wherein the overhead stream and the vapor stream are mixed to form a combined gas stream, and wherein the bottoms stream is disposed of as a concentrated acid gas stream; and
an absorption column configured to contact the combined gas stream with a preloaded absorbent stream, wherein a rich absorbent stream exits the bottom of the absorption column and a CO₂ enriched vapor stream exits the top of the column.

14. The system of paragraph 13, including:
a preloading mixer configured to contact the CO₂ enriched vapor stream with an absorbent stream to form the preloaded absorbent stream;
a presaturation chiller configured to chill the preloaded absorbent stream by exchanging heat with the liquid acid gas stream; and
a presaturation flash drum configured to flash excess CO₂ from the preloaded absorbent stream forming a CO₂ enriched product stream and the preloaded absorbent stream.

15. The systems of paragraphs 13 or 14, including a separation system configured to remove the hot acid gas from the rich absorbent stream forming the hot acid gas stream and the absorbent stream, wherein:
the hot acid gas stream is sent to the bulk liquid stripper; and
the absorbent stream is sent to the preloading mixer.

16. The systems of paragraphs 13, 14, or 15, including a cryogenic gas separation system configured to form the liquid acid gas stream.

17. A method for purifying a natural gas stream including:
dehydrating the natural gas stream;
cryogenically separating the natural gas stream into a methane rich fraction, a natural gas liquids fraction, and a liquid acid gas stream;
fractionating the liquid acid gas stream to form a CO₂ enriched stream and a liquid acid waste stream; and
treating the CO₂ enriched stream with an absorbent to remove excess H₂S forming a CO₂ product stream.

18. The method of paragraph 17, including generating power from the methane rich fraction.

19. The methods of paragraphs 17 or 18, including performing enhanced oil recovery with the CO₂ product stream.

20. The methods of paragraphs 17, 18, or 19, including regenerating the absorbent to remove the H₂S.

While the present techniques may be susceptible to various modifications and alternative forms, the exemplary embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A method for generating a CO₂ product stream, comprising:
generating a liquid acid gas stream comprising H₂S and CO₂;
flashing the liquid acid gas stream to form a first vapor stream and a bottom stream;
fractionating the bottom stream to form a second vapor stream and a liquid acid waste stream;
combining the first vapor stream and the second vapor stream to form a combined vapor stream; and
treating the combined vapor stream with a physical solvent to remove excess H₂S, forming the CO₂ product stream.

2. The method of claim 1, comprising disposing of the liquid acid waste stream in a waste disposal well.

3. The method of claim 1, wherein treating the combined vapor stream comprises:
contacting the physical solvent with an enriched CO₂ stream from an absorption column to form a preloaded physical solvent;
flashing the preloaded physical solvent to remove excess CO₂ as the CO₂ product stream; and
injecting the preloaded physical solvent into the absorption column to treat the combined vapor stream.

4. The method of claim 3, comprising:
flowing the bottom stream from the absorption column to a separation system, wherein the bottom stream comprises a rich physical solvent; and
separating an acid gas stream from the rich physical solvent.

5. The method of claim 4, comprising injecting the acid gas stream into a bulk liquid stripper to provide heat duty.

6. The method of claim 4, comprising flashing the rich physical solvent in a plurality of stages, wherein each stage is operated at a lower pressure than the proceeding stage.

7. The method of claim 4, comprising:
recompressing a vapor stream from each stage; and
cooling the recompressed vapor stream to remove water to within a solubility limit of the acid gas.

8. The method of claim 3, comprising cooling the preloaded physical solvent by exchanging heat with the liquid acid gas stream.

9. The method of claim 1, wherein generating the liquid acid gas stream comprises a Ryan-Holms process.

10. The method of claim 1, wherein generating the liquid acid gas stream comprises a cryogenic process.

11. The method of claim 1, comprising injecting the CO₂ enriched stream into a formation to enhance a recovery of a hydrocarbon.

12. The method of claim 1, comprising disposing of the liquid acid waste stream by generating solid sulfur.

13. A system for generating a CO₂ enriched stream, comprising:
an acid gas flash drum configured to flash a portion of a liquid acid gas stream into a vapor stream and a liquid stream;
a bulk liquid stripper configured to contact the liquid stream with an acid gas stream and flash at least a portion of the liquid stream into an overhead stream and a bottoms stream, wherein the overhead stream and the vapor stream are mixed to form a combined gas stream, and wherein the bottoms stream is disposed of as a concentrated acid gas stream; and
an absorption column configured to contact the combined gas stream with a preloaded absorbent stream, wherein a rich absorbent stream exits the bottom of the absorption column and a CO₂ enriched vapor stream exits the top of the column.

14. The system of claim 13, comprising:
a preloading mixer configured to contact the CO₂ enriched vapor stream with an absorbent stream to form the preloaded absorbent stream;
a presaturation chiller configured to chill the preloaded absorbent stream by exchanging heat with the liquid acid gas stream; and
a presaturation flash drum configured to flash excess CO₂ from the preloaded absorbent stream forming a CO₂ enriched product stream and the preloaded absorbent stream.

15. The system of claim 14, comprising a separation system configured to remove the hot acid gas from the rich absorbent stream forming the hot acid gas stream and the absorbent stream, wherein:
the hot acid gas stream is sent to the bulk liquid stripper; and
the absorbent stream is sent to the preloading mixer.

16. The system of claim 13, comprising a cryogenic gas separation system configured to form the liquid acid gas stream.

17. A method for purifying a natural gas stream comprising:
dehydrating the natural gas stream;
cryogenically separating the natural gas stream into a methane rich fraction, a natural gas liquids fraction, and a liquid acid gas stream;
fractionating the liquid acid gas stream to form a CO₂ enriched stream and a liquid acid waste stream; and
treating the CO₂ enriched stream with an absorbent to remove excess H₂S forming a CO₂ product stream.

18. The method of claim 17, comprising generating power from the methane rich fraction.

19. The method of claim 17, comprising performing enhanced oil recovery with the CO₂ product stream.

20. The method of claim 17, comprising regenerating the absorbent to remove the H₂S.
